(19) United States
(12) Patent Application Publication
(10) Pub. No.: US 2025/0165284 A1
(43) Pub. Date: May 22, 2025

(54) SCHEDULING USING COLLAPSED OPERATIONS

(71) Applicant: Advanced Micro Devices, Inc., Santa Clara, CA (US)

(72) Inventors: Travis Boraten, Austin, TX (US); Heather Lynn Hanson, Austin, TX (US); Yasuko Eckert, Bellevue, WA (US); Onur Kayiran, Fairport, NY (US)

(73) Assignee: Advanced Micro Devices, Inc., (omitted)

(21) Appl. No.: 18/518,204

(22) Filed: Nov. 22, 2023

(51) Int. Cl. G06F 9/48

(52) U.S. Cl. CPC G06F 9/4881

(57) ABSTRACT

A method for collapsing operations into super operations in a computing system includes dispatching a super operation corresponding to a collapsible sequence of operations to a scheduler, performing a lookup in a super operation table for the collapsible sequence of operations in response to the super operation being picked from the scheduler, and multi-pumping the collapsible sequence of operations to a pipe operationally coupled to the scheduler. For example, the multi-pumped collapsible sequence of operations may then be sequentially executed by an execution unit. The collapsible sequence of operations may be identified as collapsible according to a set of rules.

### TECHNICAL FIELD

The present invention relates generally to scheduling of operations in a processor, and, in particular implementations, methods and systems for collapsing sequences of operations for dispatch to a scheduler.

### BACKGROUND

Computer processors such as microprocessors use circuitry (e.g., electronic circuitry) to execute instructions, such as computer programs. The instructions pass through various stages of the processor on their way to being executed. For example, the instructions are decoded (converted into a form that can cause the processor to perform the instruction) and then executed. During the decoding stage, instructions may be decomposed into a sequence of basic operations of the processor (sometimes called microoperations, or μOps). The sequence is then dispatched to an execution unit.

After dispatch, the sequence of operations may be loaded into a scheduler (e.g., a scheduler in an execution unit). Each scheduler may have several pipes leading to various execution units (e.g., an arithmetic-logic unit (ALU)). The role of a scheduler in the processor pipeline is to assign operations to specific pipes. Each scheduler can hold a limited number of operations. When execution resources are free (e.g., there are available pipes), operations that are ready for execution may be picked.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an example computing system including a super operation circuit, super operation table, and a scheduler in accordance with implementations of the invention;

FIG. 2 illustrates a block diagram of another example computing system that includes a processor with a super operation circuit, a super operation table, and an execution unit that includes a scheduler operationally coupled to the super operation table in accordance with implementations of the invention;

FIG. 3 illustrates a state diagram of a finite state machine of an example super operation circuit in accordance with implementations of the invention;

FIG. 4 illustrates a state diagram of a finite state machine of another example super operation circuit in accordance with implementations of the invention;

FIG. 5 illustrates several example collapsible sequences of operations in accordance with implementations of the invention;

FIG. 6 illustrates various example collapsible sequences of operations that include one or more masked registers in accordance with implementations of the invention;

FIG. 7 illustrates more example collapsible sequences of operations that include one or more masked registers in accordance with implementations of the invention;

FIG. 8 illustrates an example dispatch stream showing tagging of collapsible sequences of operations during dispatch where the tagging is performed using flags in accordance with implementations of the invention;

FIG. 9 illustrates another example dispatch stream showing tagging of collapsible sequences of operations where the tagging is performed using fences in accordance with implementations of the invention;

FIG. 10 illustrates an example super operation table in accordance with implementations of the invention; and

FIG. 11 illustrates an example method for collapsing operations into super operations in accordance with implementations of the invention.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Schedulers can be full of operations that are not ready to be executed when one or more pipes become available. This leads to a decrease in performance as operations that are ready to be executed are waiting to enter the scheduler and pipes that are free are being underutilized. One way to decrease the chance of underutilizing pipes when the scheduler is full is to increase the number of operations that the scheduler can store (e.g., by a factor of two or three). However, this results in increasing the physical size of the scheduler itself and is not cost-effective. For example, the required area and power cost for increasing the scheduler size is high. Therefore, systems and methods that reduce the chance of underutilizing pipes without increasing the size of the scheduler are desirable.

Some compute-bound workloads can easily fill up the entire scheduler queues. When the scheduler queues are full, dispatch must stall. Because some compute-bound workloads have underutilized pipelines when this happens, performance could be improved if the scheduler queues were larger. For example, scheduler pickers have a higher probability of finding independent-and-ready μOps to fill pipes when the scheduler queues are larger. Size increases as low as 30% may afford some benefit, but consistent performance benefits may require doubling or even tripling the size of the scheduler queue.

Underutilization of scheduler pipelines (e.g., ALU pipelines in an execution unit such as an integer unit, a floating-point (FP) unit, a single instruction multiple data (SIMD) unit, etc.) due to full scheduler queues and no operations ready for execution lead to performance losses in processors. The motivation behind increasing the scheduler size to address this issue is to increase the number of queued operations (e.g., μOps) that the scheduler has to choose from. Yet, the cost of increasing the size of the scheduler for this purpose alone is too high to justify the benefit. For this reason, rather than increasing the size of the scheduler, decreasing the amount of space that operations take in the scheduler may be a desirable option.

One conventional technique for decreasing the size of operations fuses two μOps into a single μOp. Notably, the resulting fusion is itself a μOp. That is, the fused μOp meets the length and structure requirements of a single μOp. The ALU receiving the fused μOp must be able to understand the operation and the decoder must be able to combine two separate μOps into a single μOp. As a result, μOp fusion comes at the cost of extra decode (DE) and ALU support. It can also be challenging to find a set of Ops that can be fused and will benefit enough workloads to justify the cost. Consequently, most fused μOps are limited branch-related operations.

Another conventional technique for decreasing the size of operations is a form of compression. The approach allows two μOps to be compressed (i.e., merged) into a single μOp when certain conditions are met. Specifically, properties such as register counts and scheduler/pipe assignment rules may indicate that the total number of redundant/unused bits between the pair is high enough to allow both μOps to be compressed into a single μOp. Again, the result of the compression is a single μOp. To prevent excessive expansion of the opcode space with opcodes that represented merged opcodes, a compressed μOp table is used. While μOp compression allows for more μOps to be combined than μOp fusion, there are still limitations, such as only being able to combine two μOps, and the rigid requirements on redundant/unused bits. In particular, the compressed μOp still stores critical information of the pair of μOps in the scheduler queue entry itself, which constrains which μOps can be compressed.

Another possible way to reduce the space that operations take in the scheduler could be to create more complex (e.g., complex instruction set computer (CISC)-like instructions that result in multiple basic operations being performed). Yet, this too may come at a high cost because many new instructions and many variable widths would need to be supported in order to reap benefits.

In accordance with various implementations herein described, the invention proposes a method of collapsing operations into super operations for dispatch to a scheduler. Collapsible sequences of operations are identified prior to dispatch according to a set of rules. A corresponding super operation (e.g., a dispatch token) is associated with an identified collapsible sequence of operations and the super operation is dispatched instead of the collapsible sequence. When the super operation is picked from the scheduler, a lookup for the super operation is performed in a super operation lookup table. The collapsible sequence is then multi-pumped to a pipeline (i.e., the sequence of operations is sent consecutively into the pipeline) for sequential execution by an execution unit (e.g., an ALU). In this way, only a single scheduler entry is occupied by the super operation (in lieu of the two or more operations of the collapsible sequence), and a performance benefit may advantageously be achieved without increasing the scheduler queue size.

In some implementations, the method of collapsing operations into super operations is performed by a super operation circuit and a super operation table that are included in a computing system, such as a device that includes a processor. For example, the super operation circuit and the super operation table may be included in the front end circuit of a processor (or a processor core). In one implementation, the super operation circuit is operationally coupled to a decoder of a processor. In one implementation, the super operation circuit is operationally coupled to an operation cache of a processor.

The method of collapsing operations into super operations is performed by a computing system executing stored instructions (e.g., a computer program) in some implementations. For example, the instructions may be stored in a non-transitory computer-readable storage device. In one implementation, the storage device is part of a processor, and the instructions are stored as firmware. In one implementation, the instructions are stored as software on the storage device in a computing system that includes a processor.

The methods and systems described herein may realize some or all of the following advantages over conventional techniques. In particular, collapsing a sequence of operations (e.g., μOps) and replacing them with a single super operation (e.g., a super μOp, or SμOp), may have the potential to lower queue pressure throughout the core pipeline. Doing so may also improve power efficiency and improve performance since fewer operations are dispatched for the same work. In the specific case where schedulers and pipes are well balanced, it may advantageously improve processor (e.g., ALU) utilization by providing more independent sequences to choose from for the same amount of scheduler space.

Unlike conventional Op fusion discussed above, which requires hardcoding into the design, the methods and systems described herein may advantageously provide increased flexibility that allows collapsing of operations on a per benchmark basis. For example, because a set of rules is used to identify collapsible sequences of operations, the specific collapsible sequences will advantageously depend on the details of a given application.

In contrast to the conventional methods previously discussed, the described methods and systems have the benefit of storing critical information of the sequences of operations in the super operation table rather than in each scheduler entry. For example, the super operation table may store opcodes, register patterns, and immediate values while the corresponding scheduler entry stores the super opcode and (optionally) super operation-specific operands. This may have the additional advantage of allowing more than two operations to be collapsed into a super operation. Each operation in the collapse sequence higher than one represents an entry in the scheduler queue that is advantageously freed up by the super operation. Additionally, since the collapsed entries (super operation entries) require fewer bits, multiple collapsed entries may also advantageously fit into a single scheduler queue entry, which may further reduce space.

Although many of the specific examples described herein target the FP scheduler within a CPU pipeline, this invention also has the benefit of not being particular to a specific pipeline type or scheduler and can be used in any execution unit (e.g., integer, floating point, CPU, GPU, accelerator pipeline, etc.).

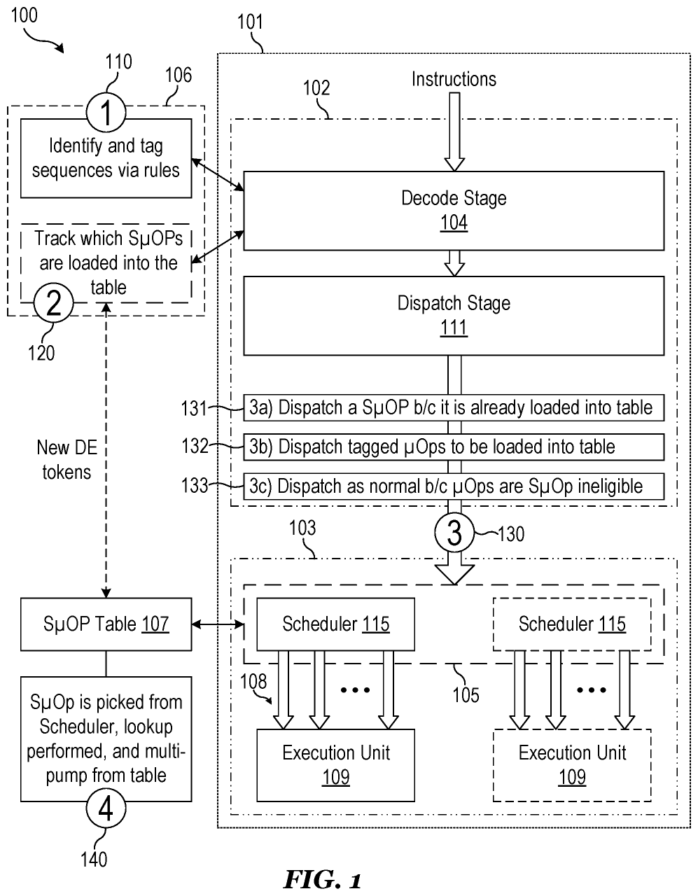

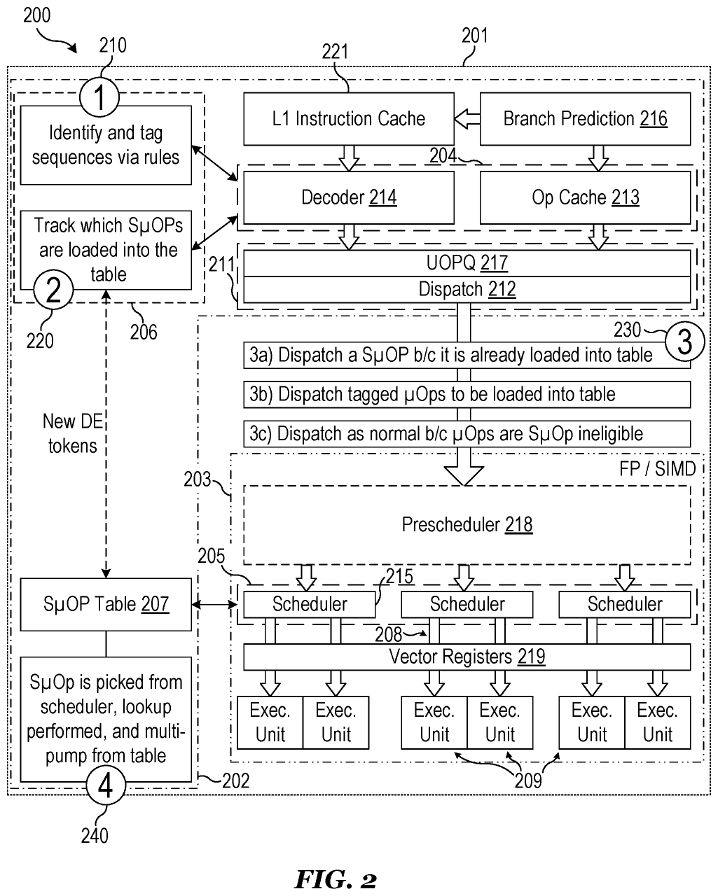

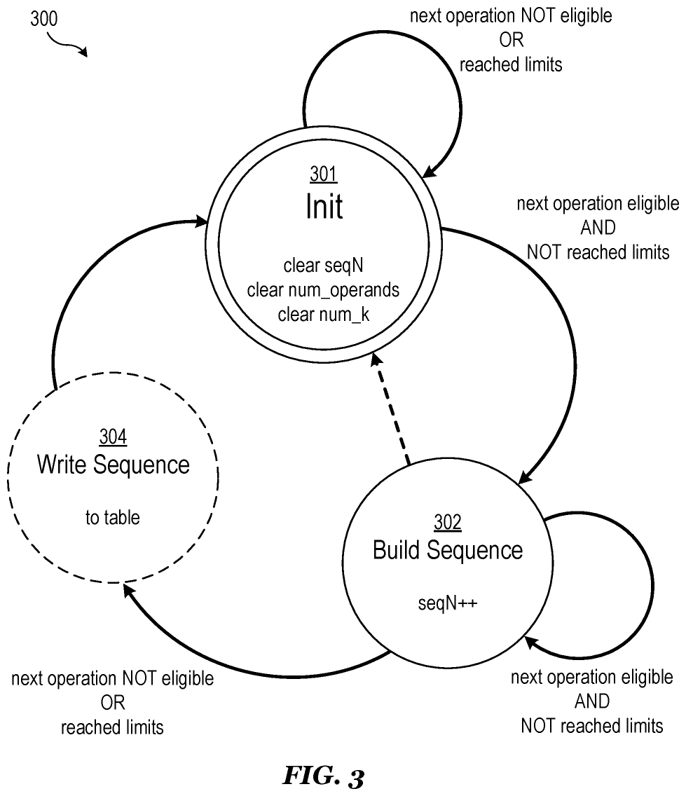

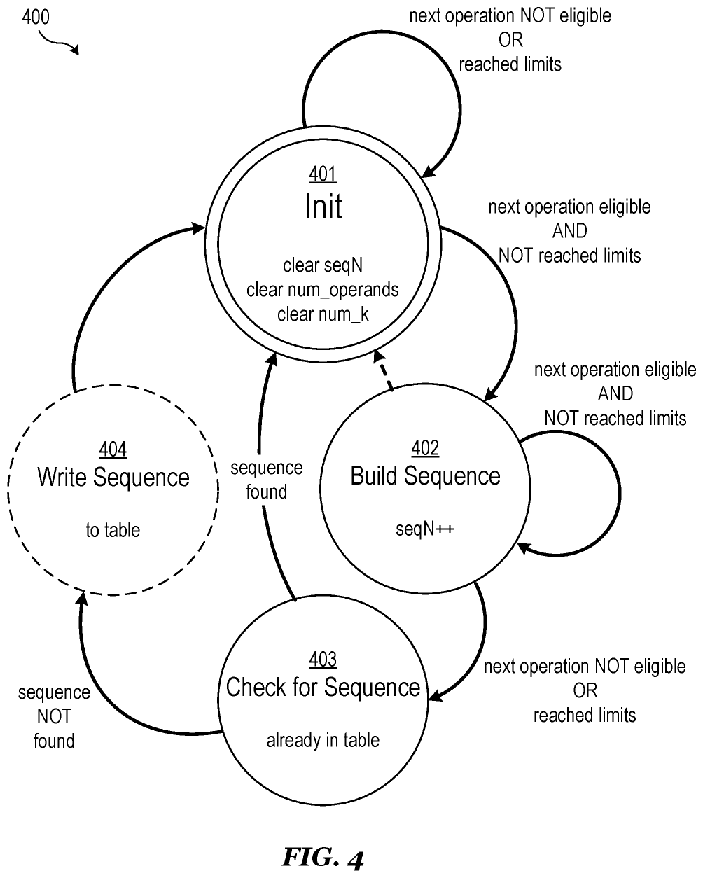

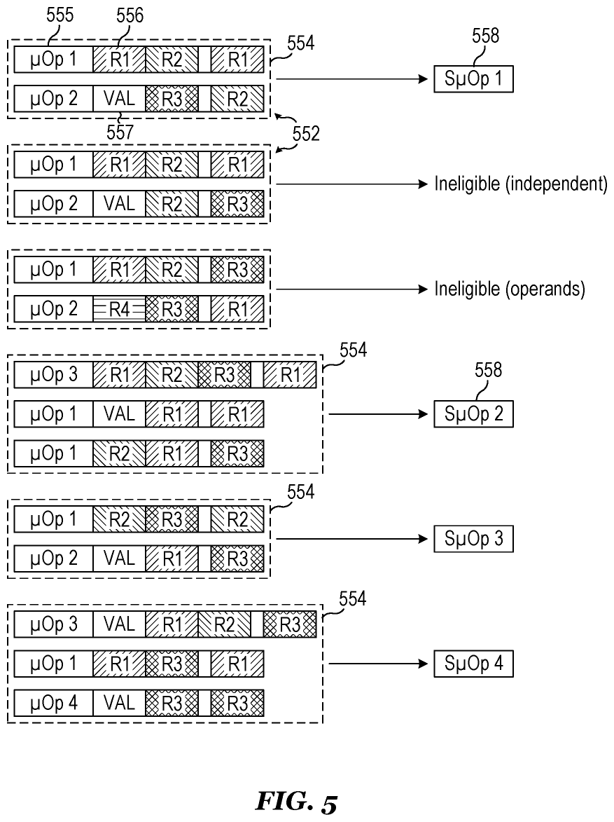

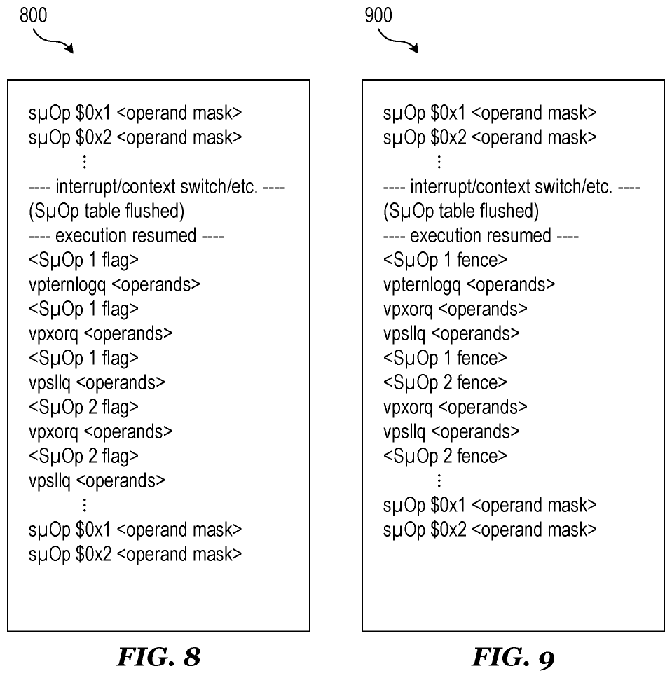

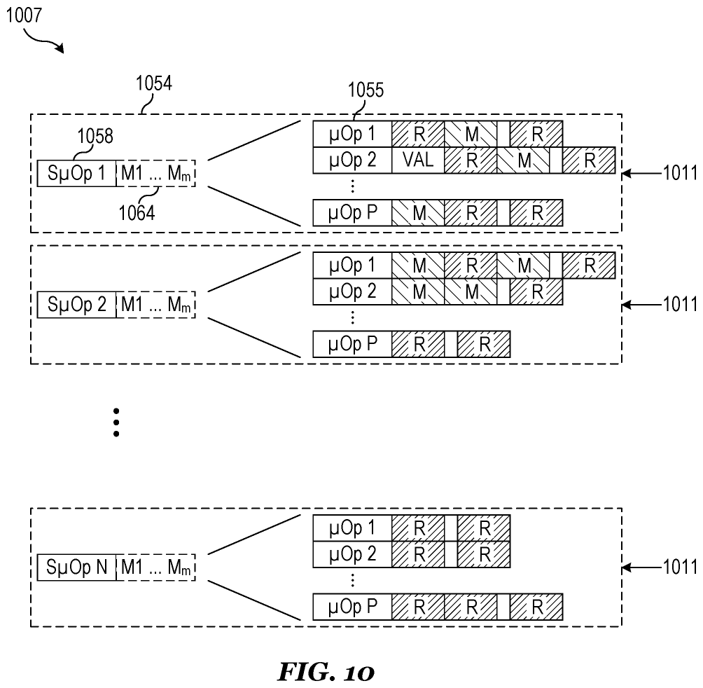

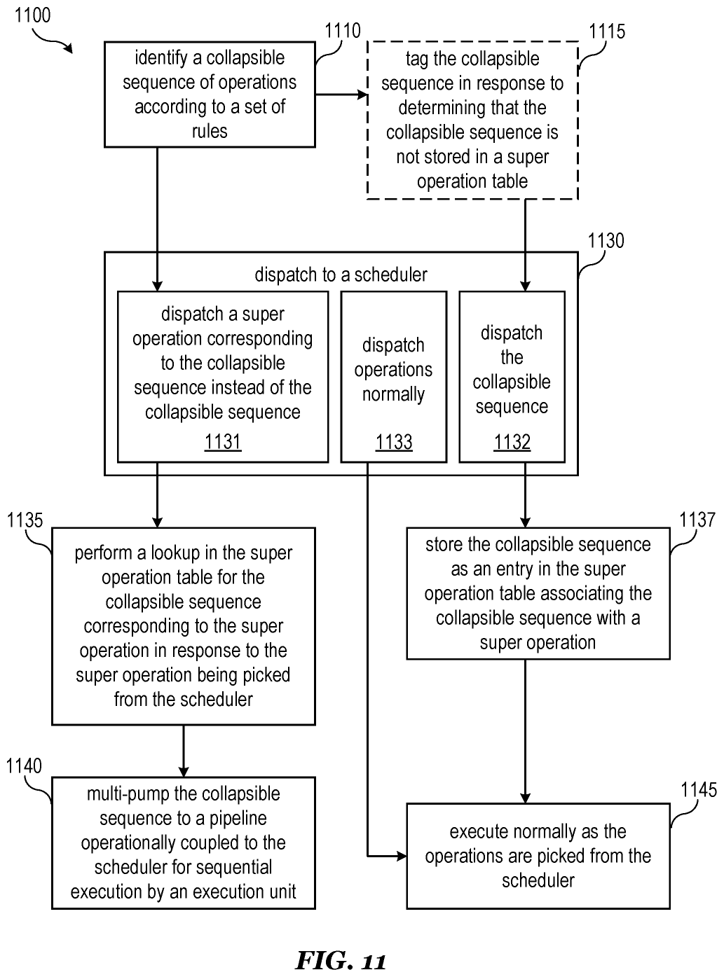

Implementations provided below describe various methods and systems for scheduling operations in a processor, and in particular implementations, methods and systems for collapsing sequences of operations into super operations for dispatch to a scheduler. The following description describes the implementations. FIG. 1 is used to describe an example computing system. Another example computing system is described using FIG. 2. FIGS. 3 and 4 are used to describe two finite state machines of example super operation circuits. Several example collapsible sequences are described using FIGS. 5-7. Two example dispatch streams are described using FIGS. 8 and 9, while an example super operation table is described using FIG. 10. An example method for collapsing operations into super operations is described using FIG. 11.

FIG. 1 illustrates a block diagram of an example computing system including a super operation circuit, super operation table, and a scheduler in accordance with implementations of the invention.

Referring to FIG. 1, a computing system 100 includes a processing unit 101 that is operationally coupled to a super operation circuit 106 and a super operation table 107. The processing unit 101 includes a decode stage 104, a dispatch stage 111, a scheduling unit 105, and at least one execution unit 109. The circuitry of the processing unit 101 may be divided between a front end unit 102 (that may include control circuitry for the processing unit 101) and a back end unit 103 (that may include execution circuitry for the processing unit 101). For example, the decode stage 104 and the dispatch stage 111 may be included in the front end unit 102 and the scheduling unit 105 and the execution unit 109 may be included in the back end unit 103. The scheduling unit 105 may have one or more schedulers 115 (e.g., scheduling queues) that are operationally coupled to one or more execution units 109 via various pipes 108.

Instructions to be executed by the processing unit 101 may pass through the various stages and units of the processing unit 101 (e.g., a processor pipeline) until they are executed by an execution unit. At the decode stage 104, the instructions may be decomposed into basic operations (e.g., μOps). For example, each basic operation may be a low-level operation specific to the processing unit 101 such as transferring data in registers or performing arithmetic or logic operations on data stored in registers. The super operation circuit 106 is configured to collapse operations (such as basic operations) into super operations (e.g., “SμOps”) in the computing system 100.

The super operation circuit 106 is configured to identify a first collapsible sequence of operations according to a set of rules. For example, the super operation circuit 106 may be operationally coupled to the processing unit 101 at a point before the dispatch stage 111, such as the decode stage 104. At the decode stage 104, the super operation circuit 106 may perform an identifying step 110 of applying a set of rules to sequences of operations to identify collapsible sequences of operations. During the identifying step 110, the super operation circuit 106 may tag collapsible sequences for dispatch. For example, when a collapsible sequence is not stored in the super operation table, the super operation circuit 106 may tag operations of the sequence and dispatch the sequence to the scheduling unit 105 (to be placed in one of the schedulers 115).

After the identifying step 110, a dispatching step 130 is performed, in which there are three possibilities. First, the identifying step 110 may result in the identification of a collapsible sequence of operations. When the identified collapsible sequence corresponds with a super operation already stored in the super operation table 107, the super operation circuit 106 dispatches the super operation corresponding to the collapsible sequence to a scheduler instead of the collapsible sequence (step 131). Second, if the identified collapsible sequence is not already stored in the super operation table 107 (and if there is room in the table), the operations of the identified collapsible sequence are dispatched to the scheduler (step 132) and the super operation circuit 106 indicates that the collapsible sequence is to be loaded into the super operation table 107 (e.g., by tagging the operations of the collapsible sequence). Third, the super operation circuit 106 may establish that operations are ineligible for collapsing (e.g., because they do not adhere to one or more of the rules) and the ineligible operations are dispatched normally (step 133).

In this way, when the collapsible sequence is already in the super operation table 107, the replacement of the super operation from the point of replacement all the way to when the super operation is placed in a scheduler saves space in all queues along the way and specifically in the scheduler queue, which frees up entries for ready-for-execution operations to be placed in the queue.

In a multi-pumping step 140, a super operation stored in a scheduler 115 of the scheduling unit 105 may be picked for execution by a picker (e.g., all of the registers used for the collapsible sequence of operations corresponding to the super operation may be available). A lookup may be performed in the super operation table 107 for the collapsible sequence corresponding to the super operation in response to the super operation being picked from the scheduler 115. The collapsible sequence may then be multi-pumped to an execution unit 109 via a pipe 108 (sent in order with no intervening operations to the execution unit 109 for sequential execution). It should be noted that with overhead, it may be possible to define and use super operations that are not executed strictly in order. Therefore, the sequential execution of the multi-pumped operations may be executed out-of-order in some implementations.

Multi-pumping the collapsible sequence of operations may advantageously not hurt performance, as the instructions in these sequences may be dependent on each other (e.g., they would execute serially in that order anyway). Since the backlog caused by chains of dependent instructions is one reason that scheduler queues are full, applying this method to dependent sequences of instructions (e.g., as a rule, discussed in further detail below) may be particularly useful to reduce queue pressure without disrupting execution. A further benefit of multi-pumping the sequences may be to save picker power while the sequences are being executed.

The first time a collapsible sequence is identified (i.e., not in the super operation table 107), a tagging system may be used to indicate that the collapsible sequence is to be stored as a super operation (e.g., loaded into the super operation table 107). For example, flags or a fence may be used in the dispatch stream to indicate that the collapsible sequence is to be stored as an entry in the super operation table 107 that associates the collapsible sequence with a super operation. The collapsible sequence is then executed normally (i.e., sequentially, but not multi-pumped). That is, the picker picks each operation individually.

During the identifying step 110, decisions are made as to how to dispatch the operations in the dispatching step 130. For this reason, the super operation circuit 106 may be optionally configured to perform a tracking step 120 to determine which sequences of operations are already in the super operation table 107 and/or which super operation dispatch tokens have been used. For example, the super operation table 107 may have a limited number of available entries, each entry storing the details of a super operation and corresponding to a super operation dispatch token. Specifically, the super operation circuit 106 may track entries in the super operation table to monitor availability of super operation dispatch tokens, such as by flagging each token as being used or free. To determine if an identified collapsible sequence is already in the super operation table 107, a lookup may be performed for an identified collapsible sequence in the tracking step 120.

In this way, the super operation circuit 106 and the super operation table 107 are configured to identify collapsible sequences (e.g., frequently used and/or dependent sequences of operations), place them in a table, look them up upon use, and multi-pump each operation within the sequences.

In the identifying step 110, a set of rules is used to determine whether a given sequence of operations is collapsible. The exact rules may depend on the details of a given application. One rule (already mentioned) may be that each operation except the first operation of a sequence in consideration be dependent on a previous operation of the sequence in consideration. For example, each of the operations in a collapsible sequence may use a register that is used by another operation of the sequence. Because the results of the sequence would change if the sequence were to be executed in a different order, the sequence must be executed in order and the operations are dependent.

While the rule requiring dependency is not required to collapse operations into super operations and free up space in scheduler queues, this rule may have the benefit of identifying sequences that will result in a performance gain, even without any knowledge of the likelihood that a given sequence of operation may be repeated. For example, dependent sequences of operations are likely to remain in queues waiting to be executed which may prevent independent operations (e.g., ready-for-execution operations) from being placed in the queues. Using the dependency rule, these dependent operations may be collapsed into a single queue entry allowing more independent operations to take up queue space.

Another possible rule is a rule that all operations of a sequence in consideration be of a single operation type. This may be important to ensure that all of the sequences in the super operation would be placed in the same type of scheduler (e.g., sent to the same type of execution unit) if dispatched individually. There is no requirement as to what the single operation type is, however. In some implementations, the single operation type is a vector operation and is a floating-point vector operation in one implementation. In another implementation, the single operation type is an integer operation. In one implementation, memory operations are excluded, but this is not necessarily a requirement.

A rule that the total number of operands used by a sequence in consideration is less than or equal to a predetermined maximum number of operands may also be used. For example, the total number of allowable operands (e.g., registers used by the sequence) may be three. This may be imposed for various reasons, such as hardware specifications. However, the exact number may vary, such as higher (e.g., 4), or lower (e.g., 2). In some cases, an operation may use one or more immediate values, which may not be considered an operand (and of course wouldn't be considered a used register). Rules regarding register usage may also include more specific rules such as limitations on types of registers. For example, in the specific case of vector operations, a rule may be used that limits the number of k-registers to one.

One possible implementation of the super operation circuit 106 is as a software implementation (e.g., instructions stored on a non-transitory computer-readable storage device that, when executed by the computing system 100, cause the computing system 100 to perform the method for collapsing operations into super operations). For example, the feature of collapsing operations into super operations may be exposed to a user (programmer or compiler) which may allow selective targeting of regions of interest. If exposed to software, the feature would need to be documented for programmers and compilers to take advantage. However, binary compatibility may be a concern when taking this approach so other implementations may be used as alternatives.

For example, the super operation circuit 106 may be implemented as a hardware widget. This widget could be attached at one or more locations in the front end unit 102 (as shown). One possible location is an operation cache (op cache). This may be advantageous since a goal of collapsing operations may be to target operations with high reuse. Another possible location is a decoder.

The super operation circuit 106 and the super operation table 107 may be included in the processing unit 101. However, in other implementations, the super operation circuit 106 and super operation table 107 may be separate from the processing unit 101. In some implementations, the super operation circuit 106 is in a front end circuit of a processor. In one implementation both the super operation circuit 106 and the super operation table 107 are both in a front end circuit of a processor. In other implementations, the super operation table 107 may be in a back end unit 103 of a processor, such as in an execution unit like an FP unit or an integer unit. In some implementations, the super operation circuit 106 may control collapsing of operations for several super operation tables, each located in respective execution units (and the super operation table 107 may choose where to put the super operations based on rules for operation type).

An intermediate implementation option of the super operation circuit 106 may be to implement some or all of the super operation circuit 106 as firmware. For example, this may decrease exposure to users and increase binary compatibility while still advantageously affording some flexibility to the definition of rules, etc. In comparison to a strictly hardware implementation, a firmware implementation may be able to be updated to suit a particular application or to further optimize the collapsing process.

The processing unit 101 may be processor, such as a general purpose processor that is able to execute general purpose computer programs (e.g., a central processing unit (CPU), accelerated processing unit (APU), etc.) or a coprocessor (e.g., a graphic processing unit (GPU), digital signal processor (DSP), floating-point unit (FPU), etc.) that is designed to performed specialized task in a computing system and expand or supplement the functionality of a general purpose processor. More than one processing unit (or cores) may be included in a single processor (called a multi-core processor). For example, multiple cores may be included on a single integrated circuit (IC) chip.

The processing unit 101 may include several schedulers 115 (e.g., physical scheduling queues) divided into any number of scheduling units 105. For example, a common scheduler may be used for more than one execution unit. Additionally or alternatively, each execution unit may have its own scheduling unit.

An execution unit may refer to various circuit blocks, such as complex circuit blocks with dedicated schedulers and multiple smaller execution units coupled to the schedules via pipes. For example, the execution unit may refer to an FP unit, a vector unit (such as a SIMD unit), an integer unit, etc. Additionally, the term execution unit may refer to the smaller execution units that are fundamental building blocks of the back end unit 103, such as an ALU, integer adder unit, integer multiplication unit, FP adder unit, FP multiplied unit, and others. For example, any combinational logic circuit that can itself execute an operation may be an execution unit.

FIG. 2 illustrates a block diagram of another example computing system that includes a processor with a super operation circuit, a super operation table, and an execution unit that includes a scheduler operationally coupled to the super operation table in accordance with implementations of the invention. The computing system of FIG. 2 may be a specific implementation of other computing systems described herein such as the computing system of FIG. 1, for example. Similarly labeled elements may be as previously described.

Referring to FIG. 2, a computing system 200 includes a processing unit 201 that is operationally coupled to a super operation circuit 206 and a super operation table 207. The processing unit 201 includes a decode stage 204, a dispatch stage 211, a scheduling unit 205, and multiple execution units 209. The computing system 200 may be a specific implementation of the computing system 100 where the processing unit 201 is a processor (or processor core) that includes the super operation circuit 206 and the super operation table 207 in the processor (e.g., as a hardware widget, firmware, or a combination thereof). The super operation circuit 206 and the super operation table 207 are configured to perform a method of collapsing operations into super operations, including an identifying step 210, an optional tracking step 220, a dispatching step 230, and a multi-pumping step 240, which may be as previously described.

The circuitry of the processing unit 102 is divided between a front end unit 202 and a back end unit 203. The front end unit 102 includes the decode stage 204 and the dispatch stage 211 as well as an instruction cache 221 (e.g., L1 instruction cache as shown) and a branch predictor 216. The decode unit 204 includes a decoder 214 and an op cache 213. As previously discussed, the super operation circuit 206 may be operationally coupled to one or more locations before the dispatch stage 211, such as the decoder 214, the op cache 213, or both, as well as other locations. In this specific example, the super operation circuit 206 and the super operation table 207 are both included in the front end unit 202. The dispatch stage 211 includes an op queue 217 (which may also store super operations, thereby also potentially gaining some advantage of the collapsed operations) and a dispatch unit 212.

The back end 203 is shown as an FP/SIMD unit in this specific example. Of course, the back end unit 203 may include other execution units such as, but not limited to, one or more integer units, load-store units, etc. The FP/SIMD unit includes a vector register 219, a scheduler 205 that includes multiple schedulers 215, each scheduler 215 including pipes 208 operationally coupled to execution units 209. For example, the execution unit 209 may include FP multipliers, FP adders, and the like. Optionally, a prescheduler 218 may be included in the FP/SIMD unit before the scheduler 205. The prescheduler 218 may include various components, such as additional queues (e.g., a non-scheduling queue), renaming functionality (such as a vector renamer), and others.

FIG. 3 illustrates a state diagram of a finite state machine (FSM) of an example super operation circuit in accordance with implementations of the invention. The super operation circuit of FIG. 3 may be a specific implementation of other super operation circuits described herein such as the super operation circuit of FIG. 1, for example. Similarly labeled elements may be as previously described.

Referring to FIG. 3, a state diagram 300 of an FSM of an example super operation circuit includes an initialization state 301 where variables used to determine if operations in sequences of operations adhere to a set of rules are reset. For example, the super operation circuit may keep track of the sequence length (seqN), the number of operands used in the sequence (num_operands), and the number of k registers (num_k), such as if the single type of allowed operation is a vector operation. In the initialization state 301 each of the variables is reset to start a new sequence (e.g., seqN, num_operands, num_k, are all set to zero).

During the initialization state 301, the FSM checks if the next operation is eligible. Because the initialization state 301 is the start of a sequence, this will be first operation of the sequence. If the next operation does not adhere to the rules, then the FSM remains in the initialization state 301 and checks the next operation. For example, in this specific example, an operation may be eligible if the operation is a vector operation and is not a memory operation. The FSM may also remain in the initialization state 301 if certain limits are reached, such as if there are no available super operation entries available in the super operation table.

When an operation is found to be eligible and no limits have been reached, the FSM transitions to a build state 302. In the build state 302, the FSM assembles a collapsible sequence. As long as the next operation continues to be eligible and limits have not been reached, the FSM grows the collapsible sequence (seqN++). In this context, limits may refer to an allowable maximum sequence length, (e.g., 3-5 operations), maximum number of operands (e.g., 3), and/or number of k-registers (e.g., 1).

At such time as the next instruction is not eligible or limits have been reached, the FSM transitions to a write state 304 where the collapsible sequence is written to the super operation table (or the operations are tagged so that they will be loaded into the super operation table as they propagate through the pipeline). Alternatively, each operation that is found to be eligible may be tagged (e.g., adding a flag to each operation) during the build state 302 alleviating the need for a specific write state 304 (illustrated by the dotted circle). After the sequence is written (or tagging has occurred), the FSM transitions back to the initialization state 301 and proceeds to check the next operation for eligibility. Additionally, there may be a minimum sequence length (e.g., 2). If only one eligible operation is found, the FSM may transition back to the initialization state 301 without writing the sequence (shown by the dotted arrow). However, this may also be accounted for in the initialization state 301, such as not proceeding to the build state 302 until seqN=2.

FIG. 4 illustrates a state diagram of a finite state machine of another example super operation circuit in accordance with implementations of the invention. The super operation circuit of FIG. 4 may be a specific implementation of other super operation circuits described herein such as the super operation circuit of FIG. 1, for example. Similarly labeled elements may be as previously described.

Referring to FIG. 4, a state diagram 400 of an FSM of an example super operation circuit includes an initialization state 401, a build state 402, and a write state 404, which may be similar to the initialization state 301, build state 302, and write state 304 as previously described. In contrast with the state diagram 300 of the FSM of FIG. 3, the state diagram 400 also includes a check state 403 in between the build state 402 and the write state 404. In the check state 403, the FSM checks to see if the sequence is already in the super operation table before transitioning to the write state 404 where the sequence is written (or the operations tagged).

FIG. 5 illustrates several example collapsible sequences of operations in accordance with implementations of the invention. The collapsible sequences of operations of FIG. 5 may be examples of sequences of operations that could be identified as collapsible by super operation circuits described herein such as the super operation circuit of FIG. 1, for example. Similarly labeled elements may be as previously described.

Referring to FIG. 5, various sequences of operations 552 are provided as examples to demonstrate collapsible sequences of operations 554 (and also not collapsible, i.e., ineligible sequences of operations. Each operation 555 has one or more register 556 and one or more immediate value 557. Based on a set rules, the sequence of operations 552 may be found eligible or ineligible to be collapsed into a super operation 558.

Using the specific example set of rules above, the first sequence of operations is eligible because μOp 2 is dependent on μOp 1 (R2 is a source register in μOp 1 and a destination register in μOp 2). Only three operands are used (R1, R2, and R3), and there are only two operation in the sequence. As a result, the sequence of operations can be collapsed into SμOp 1. In contrast, the second sequence of operations is ineligible because μOp 1 and μOp 2 are independent. Similarly, the third sequence of operations is ineligible because there are four operands (R1, R2, R3, and R4).

The fourth sequence of operations is eligible because μOp 2 depends on μOp 2 (R1), μOp 3 depends on μOp 2 (R1), there are only three operands (R1, R2, and R3), and there are only three sequences. Thus, the fourth sequence can be collapsed into SμOp 2. The fifth sequence of operations is similar to the first sequence of operations expect with a different pattern of registers. In this example, this results in the fifth sequence being collapsed into SμOp 3 (more on this later). The sixth sequence of operations is similar to the fourth sequence of operations except with different registers and two immediate values. It can be collapsed into SμOp 4.

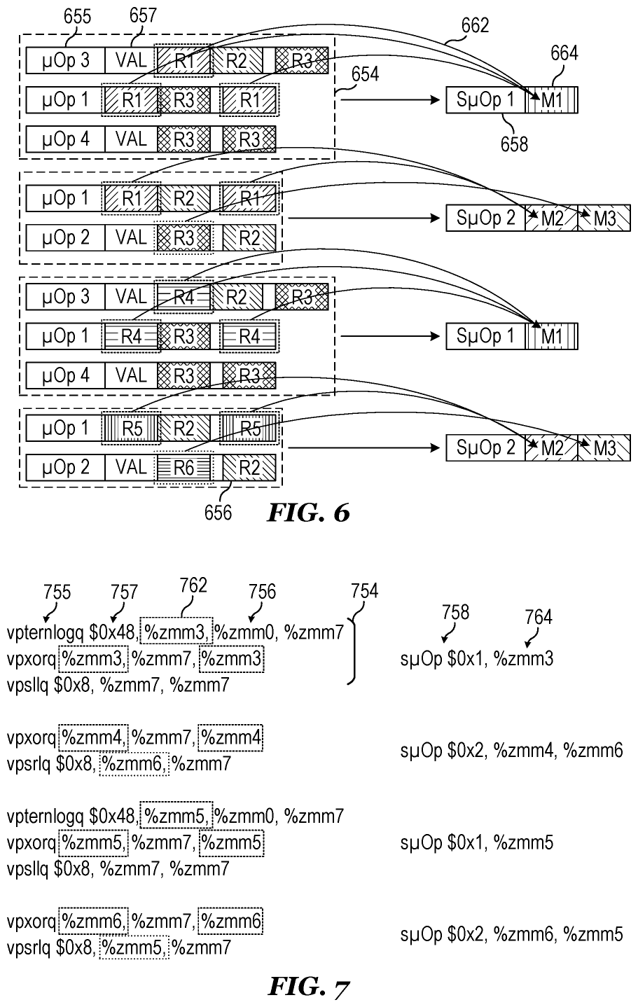

FIG. 6 illustrates various example collapsible sequences of operations that include one or more masked registers in accordance with implementations of the invention. The collapsible sequences of operations of FIG. 6 may be examples of sequences of operations that could be identified as collapsible by super operation circuits described herein such as the super operation circuit of FIG. 1, for example. Similarly labeled elements may be as previously described.

Referring to FIG. 6, various sequences of operations 652 are provided as examples to demonstrate collapsible sequences of operations 654 (and also not collapsible, i.e., ineligible sequences of operations. Each operation 655 has one or more register 656 and one or more immediate value 657. Based on a set of rules, the sequence of operations 652 may be found eligible or ineligible to be collapsed into a super operation 658.

In addition to previously discussed collapsing, the super operations 658 shown here also incorporate optional register masking. That is, the super operation circuit is further configured to identify a pattern of registers 662 used by the collapsible sequence 654 and define an operand for the super operation 658. This allows the super operation 658 to apply to any sequence that uses the same register for the pattern of registers 662. That is, when storing the collapsible sequence in the super operation table, the pattern of registers may be masked by indicating at least one operand of the super operation in the entry of the super operation table, the at least one operand corresponding to the pattern of registers.

For example, in the first sequence of operations, R1 may be replaced with any register in M1. More than one operand 664 may also be used (the maximum number of possible super operation operands may depend on the details of a specific application). In the second sequence of operations, R1 may be replaced with a different register in M2 and R3 may be replaced with a different register in M3.

This may advantageously allow more super operations to be stored in the same number of table entries. For example, the third sequence of operations adheres to the pattern of SμOp 1 with R4 in the M1 pattern. The fourth sequence has the pattern of the SμOp 2 (with R5 in M2 and R6 in M3). As a comparison, the same sequences take four entries in FIG. 5 (SμOp 1, SμOp 2, SμOp 3, and SμOp 4).

FIG. 7 illustrates more example collapsible sequences of operations that include one or more masked registers in accordance with implementations of the invention. The collapsible sequences of operations of FIG. 7 may be examples of sequences of operations that could be identified as collapsible by super operation circuits described herein such as the super operation circuit of FIG. 1, for example. Similarly labeled elements may be as previously described.

Referring to FIG. 7, a real-world example of two different sequences that might adhere to a set of rules for collapsibility is provided. The sequences of operations 752 are provided as examples to demonstrate specific examples collapsible sequences of operations 754. As before, each operation 755 has one or more register 756 and one or more immediate value 757. Based on a set of rules, the sequence of operations may be found eligible or ineligible to be collapsed into a super operation 758. Masking is also demonstrated here with patterns of registers 762 and corresponding operands 764 also being shown.

These instructions may be part of a loop within a targeted benchmark kernel that is bottlenecked by an FP scheduler. An ideal case may be when all instructions except the first in the sequence are dependent, but that is not required. As mentioned previously, collapsing independent instructions, however, could delay execution of those instructions, when the operations of each super operation are executed strictly in order.

FIG. 8 illustrates an example dispatch stream showing tagging of collapsible sequences of operations during dispatch where the tagging is performed using flags in accordance with implementations of the invention. The dispatch stream of FIG. 8 may be an example of a dispatch stream of super operation circuits described herein such as the super operation circuit of FIG. 1, for example. Similarly labeled elements may be as previously described.

Referring to FIG. 8, a dispatch stream 800 is shown that begins with a super operation table already being loaded. Table space may be tracked and monitored with dispatch tokens. After a context switch, interrupt, or exception, the super operation table may be flushed and the dispatch tokens may be reset. The super operation table may then need to be reloaded. Therefore, which operations are loaded into the table may need to be tracked. For example, the collapsible sequences of operations may be tagged. In the dispatch stream 800 individual additional flags are used to identify operations to be loaded. After the super operation table is flushed, execution is resumed and the flags indicated with operations are to be loaded as a first super operation (SμOp 1) and a second super operation (SμOp 2).

It can be noted that reloading the super operation table may advantageously have no performance penalty, as the operations are dispatched and executed as normal the first time the sequence is dispatched. Therefore, reloading the super operation table may only temporarily delay the benefit of collapsing operations. Once the first instance of a sequence is dispatched and loaded into the table, all subsequent calls can use the super operation.

FIG. 9 illustrates another example dispatch stream showing tagging of collapsible sequences of operations where the tagging is performed using fences in accordance with implementations of the invention. The dispatch stream of FIG. 9 may be an example of a dispatch stream of super operation circuits described herein such as the super operation circuit of FIG. 1, for example. Similarly labeled elements may be as previously described.

Referring to FIG. 9, a dispatch stream 900 may be similar to the dispatch stream 800 except that tagging is implemented as fence instructions at the beginning and end of each collapsible operation sequence. This makes the dispatch stream more compact, especially when collapsible sequences have larger numbers of operations.

FIG. 10 illustrates an example super operation table in accordance with implementations of the invention. The super operation table of FIG. 10 may be a specific implementation of other super operation tables described herein such as the super operation table of FIG. 1, for example. Similarly labeled elements may be as previously described.

Referring to FIG. 10, a super operation table 1007 includes multiple entries 1011 (e.g., N greater than 2) that each includes a super operation 1058 and a corresponding collapsible sequence of operations 1054. Each collapsible sequence of operations 1054 includes multiple operations 1055. As previously discussed, the super operation 1058 may utilize register masking allowing one or more operands 1064 to be included to enhance flexibility of the defined super operations.

The super operation table 1007 may not need to be very big to provide benefits. For example, in some implementations, the super operation table 1007 includes at most three entries 1011, each entry storing at most five operations 1055 in each collapsible sequence 1054. Any size of table and sequence is of course possible and may depend on the degree of benefit gained compared to the cost of increasing the table size.

The super operation table 1007 itself may be placed within various locations. In one implementation, the super operation table 1007 is a separate entity that has ports to the execution units (e.g., ALUs) that the picker has access to. In another implementation, the super operation table 1007 is implemented as a separate scheduler queue. In that case, instead of loading into a separate table, a given sequence may be allocated/locked in the separate scheduler queue and the table call would point to the alternative scheduler queue. For example, a possible benefit of this implementation, might be that the super operation table may be repurposes as a normal scheduler queue when not using the super operation feature. However, having a separate table may be desirable as multiple table entries in a separate block may equal the size of one scheduler entry. In the event that the super operation table 1007 is full, no new sequences would be created a policy is used to eject sequences with less reuse to create more available space in the table.

FIG. 11 illustrates an example method for collapsing operations into super operations in accordance with implementations of the invention. The method of FIG. 11 may be combined with other methods and performed using the systems and apparatuses as described herein. For example, the method of FIG. 11 may be combined with any of the implementations of FIGS. 1-10. Although shown in a logical order, the arrangement and numbering of the steps of FIG. 11 are not intended to be limited. The method steps of FIG. 11 may be performed in any suitable order or concurrently with one another as may be apparent to a person of skill in the art.

Referring to FIG. 11, a method 1100 for collapsing operations into super operations may include an identifying step 1110 of identifying a collapsible sequence of operations according to a set of rules. A super operation corresponding to the identified collapsible sequence is dispatched instead of the collapsible sequence in a step 1131 of a dispatching step 1130. In a lookup step 1135, a lookup in the super operation table for the collapsible sequence corresponding to the super operation is performed in response to the super operation being picked from the scheduler. The collapsible sequence is then multi-pumped to a pipeline operationally coupled to the scheduler for sequential execution by an execution unit in a multi-pumping step 1140.

Optionally, in a tagging step 1115, the collapsible sequence is tagged when the collapsible sequence is not stored in a super operation table. The tagged collapsible sequence may then be dispatched in a step 1132 of the dispatching step 1130. The collapsible sequence is then stored as an entry in the super operation table associating the collapsible sequence with a super operation in a storing step 1137. In a third possibility, if no collapsible sequence is identified, operations may be dispatched normally in a step 1133 of the dispatching step 1130 (e.g., until a collapsible sequence is identified. After either step 1132 or step 1133, operations are executed normally in an execution step 1145 as the operations are picked from the scheduler.

Various example implementations are provided in the following. Other implementations may be understood from the entirety of the specification as well as the claims filed herein.

In accordance with an implementation, a method for collapsing operations into super operations in a computing system, dispatching a first super operation corresponding to a first collapsible sequence of operations to a scheduler (i.e., instead of the first collapsible sequence), performing a lookup in a super operation table for the first collapsible sequence (which corresponds to the first super operation) in response to the first super operation being picked from the scheduler, and multi-pumping the first collapsible sequence to a pipe operationally coupled to the scheduler. For example, the multi-pumped first collapsible sequence of operations may then be sequentially executed by an execution unit.

In accordance with another implementation, a device for collapsing operations into super operations includes a super operation circuit and a super operation table operationally coupled to the super operation circuit and a scheduler. The super operation circuit is configured to identify a first collapsible sequence of operations according to a set of rules, and tag the first collapsible sequence for dispatch to the scheduler as a first super operation instead of the first collapsible sequence. The super operation table is configured to store entries in the super operation table where each entry associates a super operation with a corresponding collapsible sequence of operations, perform a lookup in the super operation table for the first collapsible sequence corresponding to the first super operation picked from the scheduler, and multi-pump the first collapsible sequence to a pipe operationally coupled to the scheduler for sequential execution by an execution unit.

In still another implementation, a non-transitory computer-readable storage device stores instructions that, when executed by a computing system, cause the computing system to perform a method for collapsing operations into super operations that includes dispatching a first super operation corresponding to the first collapsible sequence of operations to a scheduler (i.e., instead of the first collapsible sequence of operations), performing a lookup in a super operation table for the first collapsible sequence (which corresponds to the first super operation) in response to the first super operation being picked from the scheduler, and multi-pumping the first collapsible sequence to a pipe operationally coupled to the scheduler. For example, the first collapsible sequence may then be sequentially executed by an execution unit.

Various implementations may include one or more of the following features. A second collapsible sequence of operations may also be identified according to the set of rules. A lookup in the super operation table may be performed for the second collapsible sequence. The second collapsible sequence may be tagged when the second collapsible sequence is not stored in the super operation table. The second collapsible sequence may be dispatched to the scheduler and the second collapsible sequence may be stored as an entry in the super operation table associating the second collapsible sequence with a second super operation.

A pattern of registers used by the second collapsible sequence may be identified. When the second collapsible sequence is stored, the pattern of registers may be masked by indicating at least one operand of the second super operation in the entry of the super operation table where the at least one operand corresponds to the pattern of registers.

The set or rules may include any of variety of rules, including a rule that each operation except the first operation of a sequence in consideration be dependent on a previous operation of the sequence in consideration, a rule that all operations of a sequence in consideration be of a single operation type, a rule that the total number of operands used by a sequence in consideration be less than or equal to a predetermined maximum number of operands, and others.

Entries in the super operation table may be tracked (e.g., by the super operation circuit) to monitor availability of super operation dispatch tokens. The super operation table may be any size, but may be relatively small in some implementations, for example having at most three entries where each entry storing at most five operations in each collapsible sequence. Both the super operation circuit and the super operation table may be in a front end circuit of a processor. The super operation circuit may be operationally coupled to a decoder of the front end circuit. The super operation circuit may be operationally coupled to an operation cache of the front end circuit.

The computing system may be a processor that includes the scheduler, the execution unit, and the non-transitory computer readable storage device and the instructions may be stored as firmware in the non-transitory computer readable storage device. The computing system may also include the processor that includes the scheduler and the execution unit. and the instructions may be stored as an executable program in the non-transitory computer readable storage device separately from the processor.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method for collapsing operations into super operations in a computing system, the method comprising:
dispatching a first super operation corresponding to a first collapsible sequence of operations to a scheduler;
performing a lookup in a super operation table for the first collapsible sequence of operations in response to the first super operation being picked from the scheduler; and
multi-pumping the first collapsible sequence of operations to a pipe operationally coupled to the scheduler.

2. The method of claim 1, further comprising:
performing a lookup in the super operation table for a second collapsible sequence of operations;
tagging the second collapsible sequence of operations when the second collapsible sequence of operations is not stored in the super operation table;
dispatching the second collapsible sequence of operations to the scheduler; and
storing the second collapsible sequence of operations as an entry in the super operation table associating the second collapsible sequence of operations with a second super operation.

3. The method of claim 2, wherein storing the second collapsible sequence of operations comprises masking the pattern of registers by indicating at least one operand of the second super operation in the entry of the super operation table, the at least one operand corresponding to a pattern of registers used by the second collapsible sequence of operations.

4. The method of claim 1, wherein each operation except the first operation of the first collapsible sequence of operations is dependent on a previous operation of the first collapsible sequence of operations.

5. The method of claim 1, wherein all operations of the first collapsible sequence of operations be of a single operation type.

6. The method of claim 1, wherein the total number of operands used by the first collapsible sequence of operations is less than or equal to a predetermined maximum number of operands.

7. A device for collapsing operations into super operations, the device comprising:
a super operation circuit configured to tag a first collapsible sequence of operations for dispatch to a scheduler as a first super operation; and
a super operation table operationally coupled to the super operation circuit and the scheduler, the super operation table being configured to
store entries in the super operation table, each entry associating a super operation with a corresponding collapsible sequence of operations,
perform a lookup in the super operation table for the first collapsible sequence of operations in response to the first super operation being picked from the scheduler, and
multi-pump the first collapsible sequence of operations to a pipe operationally coupled to the scheduler.

8. The device of claim 7, wherein the super operation circuit is further configured to tag a second collapsible sequence of operations for storing in the super operation table as a second super operation and for dispatch to the scheduler as the second collapsible sequence of operations when the second collapsible sequence of operations is not stored in the super operation table.

9. The device of claim 7, wherein the super operation circuit is further configured to track entries in the super operation table to monitor availability of super operation dispatch tokens.

10. The device of claim 7, wherein both the super operation circuit and the super operation table are in a front end circuit of a processor.

11. The device of claim 10, wherein the super operation circuit is operationally coupled to a decoder of the front end circuit.

12. The device of claim 10, wherein the super operation circuit is operationally coupled to an operation cache of the front end circuit.

13. The device of claim 7, wherein the super operation table comprises at most three entries, each entry storing at most five operations in each collapsible sequence of operations.

14. A non-transitory computer-readable storage device storing instructions that, when executed by a computing system, cause the computing system to perform a method for collapsing operations into super operations, the method comprising:
dispatching a first super operation corresponding to a first collapsible sequence of operations to a scheduler;
performing a lookup in a super operation table for the first collapsible sequence of operations in response to the first super operation being picked from the scheduler; and
multi-pumping the first collapsible sequence of operations to a pipe operationally coupled to the scheduler.

15. The non-transitory computer-readable storage device of claim 14, wherein the computing system is a processor comprising the scheduler, the execution unit, and the non-transitory computer readable storage device, and wherein the instructions are stored as firmware in the non-transitory computer readable storage device.

16. The non-transitory computer-readable storage device of claim 14, wherein the computing system comprises a processor comprising the scheduler and the execution unit, and wherein the instructions are stored as an executable program in the non-transitory computer readable storage device separately from the processor.

17. The non-transitory computer-readable storage device of claim 14, storing the instructions that cause the computing system to perform the method for collapsing operations into super operations, the method further comprising:
performing a lookup in the super operation table for a second collapsible sequence of operations;
tagging the second collapsible sequence of operations when the second collapsible sequence of operations is not stored in the super operation table;
dispatching the second collapsible sequence of operations to the scheduler; and
storing the second collapsible sequence of operations as an entry in the super operation table associating the second collapsible sequence of operations with a second super operation.

18. The non-transitory computer-readable storage device of claim 17, storing the instructions that cause the computing system to perform the method for collapsing operations into super operations, wherein storing the second collapsible sequence of operations comprises masking the pattern of registers by indicating at least one operand of the second super operation in the entry of the super operation table, the at least one operand corresponding to a pattern of registers used by the second collapsible sequence of operations.

19. The non-transitory computer-readable storage device of claim 14, wherein each operation except the first operation of the first collapsible sequence of operations be dependent on a previous operation of the first collapsible sequence of operations.

20. The non-transitory computer-readable storage device of claim 14, wherein all operations of the first collapsible sequence of operations be of a single operation type.
